(19) United States
(12) Patent Application Publication
(10) Pub. No.: US 2006/0175509 A1
(43) Pub. Date: Aug. 10, 2006

(54) Supporting shelf

(76) Inventor: Chin-Chu Li, Taipei (TW)

Correspondence Address: CHIN-CHU LI, P.O. BOX 26-757, TAIPEI, 106, TW

(21) Appl. No.: 11/051,932

(22) Filed: Feb. 4, 2005

(51) Int. Cl. G02F 1/1335; A47F 5/00

(52) U.S. Cl. 248/316.8

(57) ABSTRACT

A supporting shelf comprises at least one fixing seat having a fixing shelf for connecting to a base seat, and having a side face thereof for connecting to a firm place; and at least one fixing rod having a side face thereof for connecting to a further side face of the fixing seat, and having a further side face thereof for connecting to a side face of a object, whereby the supporting shelf is an easily demounted and easily remounted wall-supported shelf, which is for attaching and erecting a LCD TV upon. The supporting shelf has an adjustable viewing angle for adjusting the viewing angle of the LCD TV.

### BACKGROUND OF THE INVENTION

1. Field of the Invention

The present invention relates to a supporting shelf, and more particularly, to a wall-supported shelf designed for supporting an LCD TV in an upright, erect position.

2. Description of the Related Art

Today, in order to satisfy consumers' enjoyment of TV or movies, many restaurants and bars set an LCD TV on a wall of their business place so that their customers can watch something while they are waiting for or enjoying their meal. However, the conventional way to set an LCD TV on the wall is through a conventional supporting shelf. An end face of the supporting shelf is fixed onto the wall, and the LCD TV is fixed at a further end face of the supporting shelf. Although attaching the LCD TV onto the wall satisfies the customers' desire to watch TV, due to the fixed position of the LCD TV, it cannot be moved. Aside from demounting the supporting shelf, and then resetting it at a position there is no way to adjust the position of the TV. But such a procedure is extremely time-consuming and inconvenient.

### SUMMARY OF THE INVENTION

It is therefore a principal objective of the present invention to provide an easily demounted and easily remounted wall-supported shelf designed for supporting an LCD TV in an upright, erect position.

Furthermore, a further objective of the present invention is to provide a wall-supported shelf having an adjustable viewing angle so that the viewing angle of the LCD TV may be changed. The present invention has been accomplished to eliminate the aforesaid problem.

To achieve the above objective, one feature of the present invention provides a supported shelf, including at least one fixing seat having a fixing shelf for connecting to a base seat, and having a side face thereof for connecting to a firm place; and at least one fixing rod having a side face for connecting to the fixing seat, and having a further side face thereof for connecting to a side face of an object such as an LCD TV.

To provide further understanding of the invention, the following detail description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a decomposition view of the preferred embodiment of the present invention.

FIG. 2 is a composition view of the preferred embodiment of the present invention.

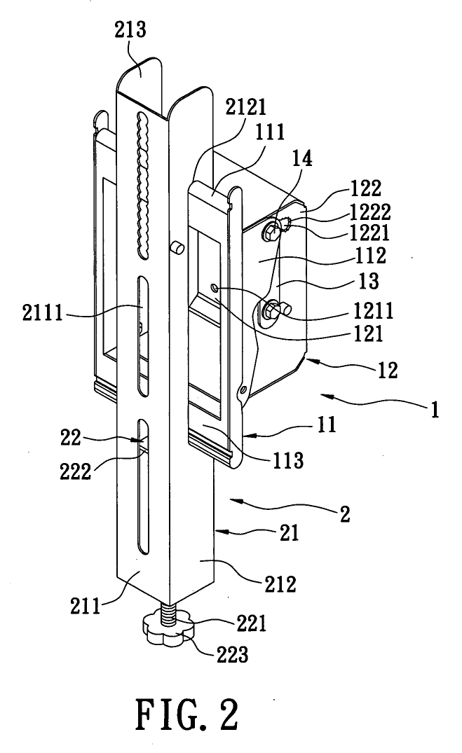

FIG. 3 is a side view of the preferred embodiment of the present invention.

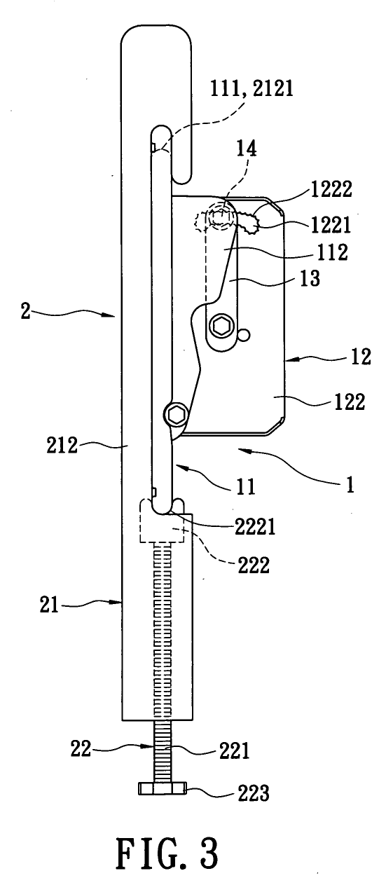

FIG. 4 is a side view of the preferred embodiment of the present invention in use with a liquid crystal display TV attached.

FIG. 5 is a perspective view of a pair of the preferred embodiments of the present invention in use with a liquid crystal display TV attached.

FIG. 6 is a side view of a further preferred embodiment of the present invention.

### DETAILED DESCRIPTION OF PREFERRED EMBODIMENTS

Referring now to the attached drawings that are shown are for the purposes of illustrating the preferred embodiments of the present invention only, and not for the purposes of limiting the same.

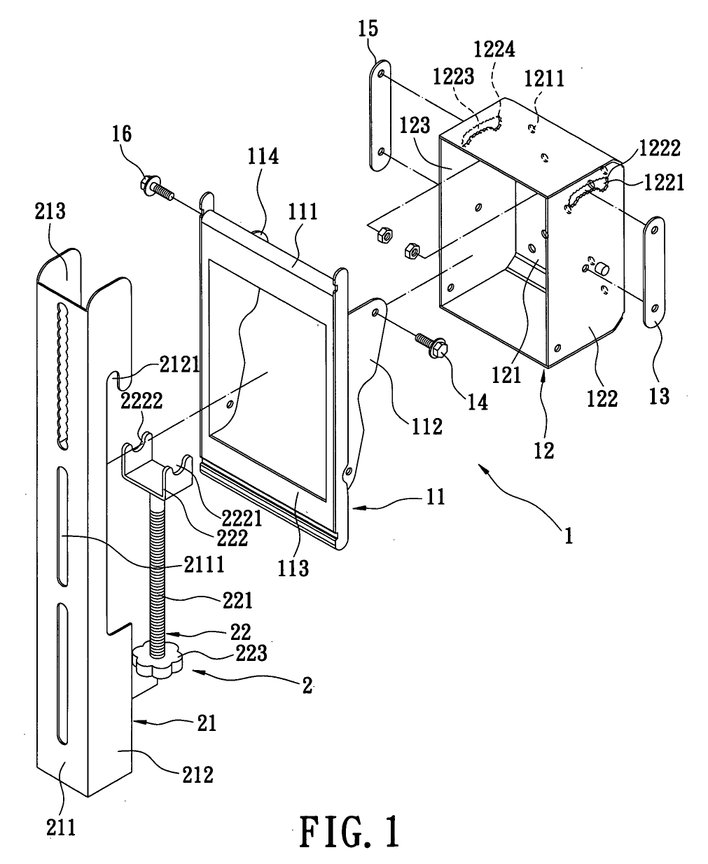

Please refer to FIGS. 1 to. 4 that show the present invention of a supporting shelf including a fixing seat 1 and a fixing rod 2.

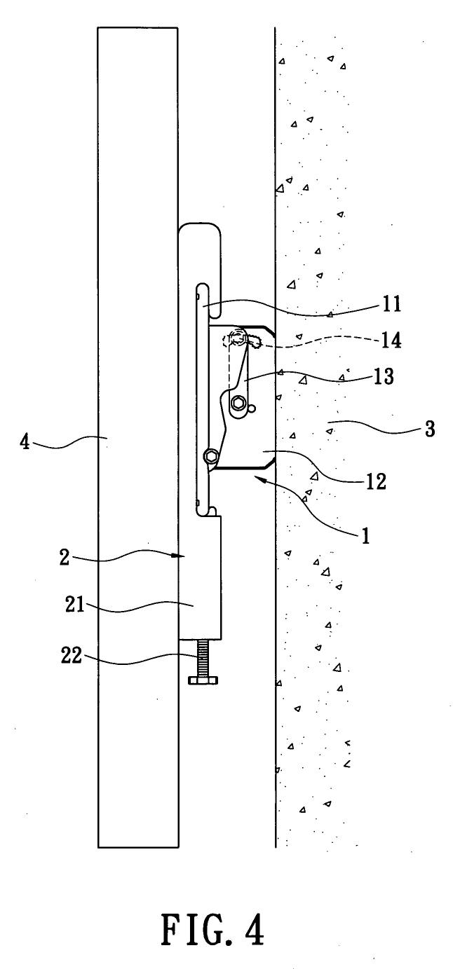

The fixing seat 1 has a fixing shelf 11 and a base seat 12. The fixing shelf 11 connects to the base seat wherein the fixing shelf has a square shape. An opening is defined on the fixing shelf. Two crossing shelves, which are a first cross-shelf 111 and a second cross-shelf 113, are formed respectively on two opposite side edges of the opening. The two crossing shelves 111 and 113 are provided for the fixing rod 2 to be erected upon. Two connecting pieces, which are a first bent connecting piece 112 and a second bent connecting piece 114, are bent to form respectively on two further opposite side edges of the opening. Each of the two bent connecting pieces 112 and 114 is defined with a plurality of fixing holes. The base seat 12 has a base side 121. The base side 121 has a plurality of fixing holes 1211. The fixing holes 1211 are provided respectively for a plurality of fixing elements to attach the base seat 12 onto the wall, so that a side face of the fixing shelf 11 connects to a firm place, such as a wall 3 as shown in FIG. 4. Two sidewalls, which are a first sidewall 122 and a second sidewall 123, are formed respectively on two opposite side edges of the base side 121. Each of the two sidewalls 122 and 123 is respectively defined with a first sliding groove 1221 and a second sliding groove 1223. A first positioning part 1222 is formed on a perimeter edge of the first sliding groove 1221. A second positioning part 1224 is formed on a perimeter edge of the second sliding groove 1223. Each of the two bent connecting pieces 112 and 114 is connected respectively to each of the two sidewalls 122 and 123. The fixing seat 1 further comprises two connecting bars, which are a first connecting bar 13 and a second connecting bar 15. Each of the two connecting bars 13 and 15 has an end pivotally connecting to each of the two sidewalls 122 and 123 of the base seat 12. Each of the two connecting bars 13 and 15 has a further end pivotally connecting to each of the bent connecting pieces 112 and 114 of the fixing shelf 11 through two pivots. The two pivots are a first pivot 14 and a second pivot 16. Each of the two pivots 14 and 16 is disposed in each of the two sliding grooves 1221 and 1223. Each of the two positioning parts 1222 and 1224 is formed on the perimeter edge of each of the two sliding grooves 1221 and 1223 and provides a positioning function for each of the two pivots 14 and 16. Hence, each of the two positioning parts 1222 and 1224 is to be used for increasing the resistance of each of the two pivots 14 and 16 in each of the two sliding grooves 1221 and 1223. In this way, both the fixing shelf 11 and the base seat 12 have a reciprocating motion between each other through the arrangement of the two connecting bars 13 and 15 and the two sliding grooves 1221 and 1223.

The fixing rod 2 has a side face connecting to the fixing seat 1. A further side face of the fixing rod 2 connects to a side face of an object, such as an LCD TV 4. The fixing rod 2 has a casing 21 and a retaining element 22. The retaining element 22 is disposed on the casing 21. The casing 21 is an open casing with the shape of a rectangle. The casing 21 has a base side 211. The base side 211 is defined with a plurality of fixing grooves 2111. The fixing grooves 2111 are provided for a plurality of fixing elements to attach the LCD TV 4 onto. Because each of the fixing grooves 2111 is longitudinally shaped, the fixing elements according to the different size of the LCD TV are moved in the fixing grooves 2111 for proper adjustment. Two sidewalls 212 and 213 are formed respectively on two opposite side edges of the base side 211. Each of the two sidewalls 212 and 213 has a hook 2121 mounted on the first cross-shelf 111 of the fixing shelf 11. Furthermore, the retaining element 22 has an adjusting rod 221 connected to a retaining part 222 with an end thereof. A further end of the adjusting rod 221 is connected to a knob 223. The knob 223 is provided so that a user can conveniently adjust the adjusting rod 221 of the retaining element 22. The retaining part 222 has two opposing grooves, which are a first groove 2221 and a second groove 2222, mounted to a further one of the two cross shelves, which is the second cross-shelf 113 of the fixing shelf 11. The LCD TV 4 connected to the fixing rod 2 is erected on the two cross shelves 111 and 113 of the fixing seat 1, as shown in FIG. 4. If the user wants to demount the LCD TV 4 erected on the fixing rod 2, they just need to adjust the adjusting rod 221 of the retaining element 22 to accomplishing demounting.

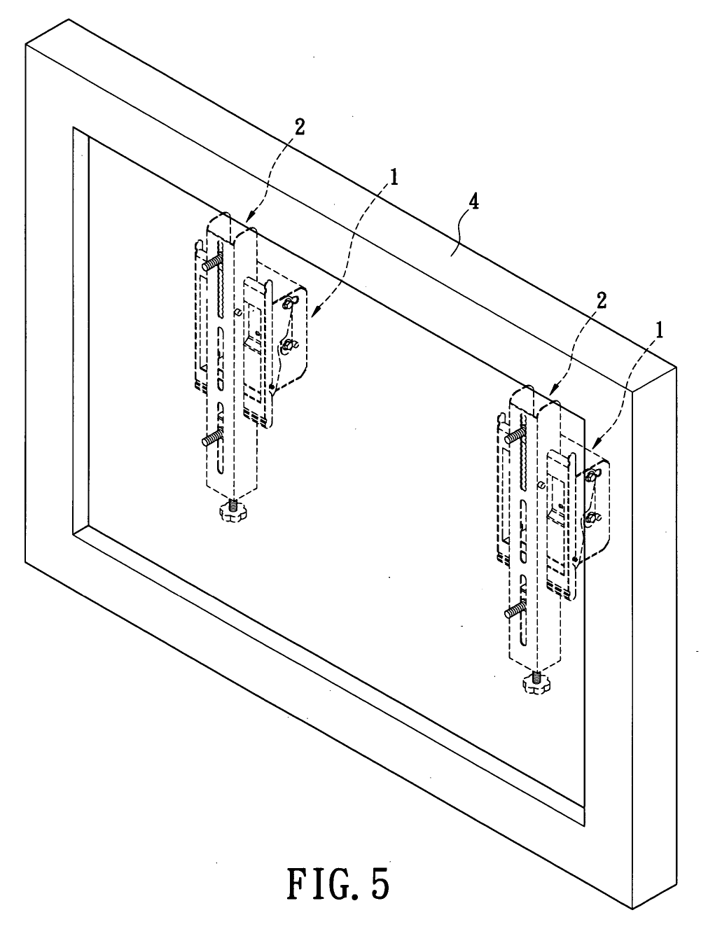

Referring to FIG. 5, which is a perspective view of a pair of the preferred embodiments of the present invention disposed with a liquid crystal display TV attached. When actually using the present invention to attach an object, such as an LCD TV, to a firm point, not only a single fixing seat 1 and a single fixing rod 2 can be applied. A plurality of fixing seats and fixing rods of the present invention can also be applied.

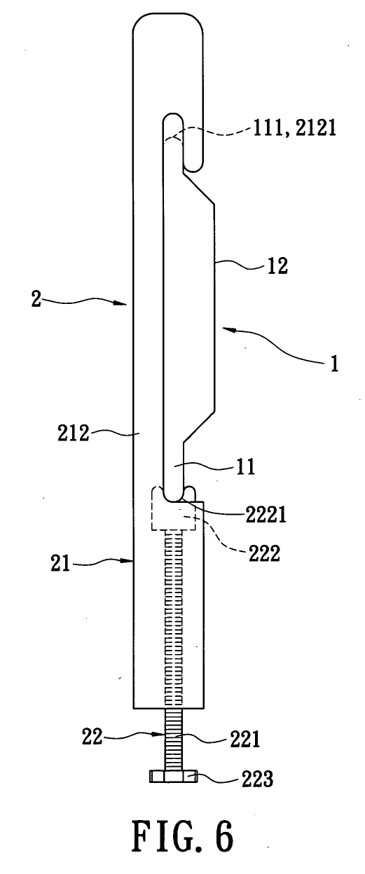

Please refer to FIG. 6 that is a side view of a further preferred embodiment of the present. The fixing shelf 11 and the base seat 12 are formed of a piece of metal, so the base seat 12 is integrally formed with the fixing shelf 11. The other configuration is the same as the aforesaid present invention.

So, the present invention has the following characteristics:

1) The fixing seat 1 comprises two connecting bars, which are a first connecting bar 13 and a second connecting bar 15. Each of the two connecting bars 13 and 15 has an end pivotally connecting to each of the two sidewalls 122 and 123 of the base seat 12. Each of the two connecting bars 13 and 15 has a further end pivotally connecting to each of the bent connecting pieces 112 and 114 of the fixing shelf 11 through two pivots. The two pivots are a first pivot 14 and a second pivot 16. Each of the pivots 14 and 16 is disposed in each of the two sliding grooves 1221 and 1223, hence both the fixing shelf 11 and the base seat 12 have a reciprocating motion between each other through the arrangement of the two connecting bars 13 and 15 and the two sliding grooves 1221 and 1223, for adjusting the viewing angle of the LCD TV 4 erected on the fixing rod 2.

2) The retaining element 22 has an adjusting rod 221 connected to a retaining part 222 with an end thereof. A further end of the adjusting rod 221 is connected to a knob 223. The knob 223 is provided so that a user can conveniently adjust the adjusting rod 221 of the retaining element 22. The retaining part 222 has two opposing grooves, which are a first groove 2221 and a second groove 2222, mounted to a further one of the two cross shelves, the other one of the two cross shelves is the second cross-shelf 113 of the fixing shelf 11. The LCD TV 4 connected to the fixing rod 2 is erected on the two cross shelves 111 and 113 of the fixing seat 1, as shown in FIG. 4. If the user wants to demount the LCD TV 4 erected on the fixing rod 2, they just need to adjust the adjusting rod 221 of the retaining element 22 to accomplish demounting.

There has thus been described a new, novel and heretofore unobvious supporting shelf eliminating the aforesaid problem of the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A supporting shelf, comprising:
at least one fixing seat having a fixing shelf for connecting to a base seat, and having a side face thereof for connecting to a firm place; and
at least one fixing rod having a side face for connecting to the fixing seat, and having a further side face thereof for connecting to a side face of an object such as an LCD TV.

2. The supporting shelf of claim 1, wherein the fixing shelf defines an opening, and the fixing shelf has two cross shelves formed respectively on two opposite side edges of the opening, and the fixing shelf has also two bent connecting pieces that respectively form two further opposite side edges of the opening.

3. The supporting shelf of claim 2, wherein the base seat has a base side defining a plurality of fixing holes, and the base seat has two sidewalls formed on two opposite side edges of the base side, and each of the two sidewalls defines a sliding groove, and each of the two sliding grooves defines a positioning part formed on each perimeter edge thereof, and each of the two bent connecting pieces is connected respectively to each of the two sidewalls.

4. The supporting shelf of claim 3, wherein the fixing seat further comprises at least one connecting bar having an end thereof for pivotally connecting to one of the two sidewalls of the base seat, and having a further end thereof for pivotally connecting to one of the two bent connecting pieces of the fixing shelf through a pivot disposed in one of the two sliding grooves.

5. The supporting shelf of claim 4, wherein the fixing rod has a casing and a retaining element, and the retaining element is disposed on the casing.

6. The supporting shelf of claim 5, wherein the casing has a base side defining a plurality of fixing grooves, and the casing has two sidewalls formed on two opposite side edges of the base side, and each of the two sidewalls has a hook for mounting to one of the two cross shelves of the fixing shelf.

7. The supporting shelf of claim 6, wherein the retaining element has an adjusting rod having an end thereof for connecting to a retaining part, and having a further end thereof for connecting to a knob, and the retaining part has two opposing grooves for mounting to a further one of the two cross shelves of the fixing shelf.

8. The supporting shelf of claim 1, wherein the object is a liquid crystal display TV.
